(19) United States
(12) Patent Application Publication
(10) Pub. No.: US 2019/0377911 A1
(43) Pub. Date: Dec. 12, 2019

(54) POSITIONING APPARATUS AND CARD ISSUING MACHINE

(71) Applicant: Shenzhen Tianyi Technology Co., Ltd., Shenzhen (CN)

(72) Inventors: Bin Wu, Shenzhen (CN); Xiaodong Qian, Shenzhen (CN); Kai Liu, Shenzhen (CN); Su Rong, Shenzhen (CN)

(73) Assignee: Shenzhen Tianyi Technology Co., Ltd., Shenzhen (CN)

(21) Appl. No.: 16/434,536

(22) Filed: Jun. 7, 2019

(30) Foreign Application Priority Data
Jun. 8, 2018 (CN) 201820888252.6

(51) Int. Cl. G06K 7/04

(52) U.S. Cl. CPC G06K 7/04

(57) ABSTRACT

A positioning apparatus includes a sensor assembly, a moving member, and a detecting plate. The sensor assembly includes a sensor positioning and detecting assembly and a sensor location recognition assembly. The sensor assembly is mounted on the moving member, and the moving member drives the sensor assembly to move on the detecting plate. The sensor assembly moves on the detecting plate, the sensor location recognition assembly recognizes that the sensor assembly reaches a designated location, and the sensor assembly is positioned by the sensor positioning and detecting assembly. The positioning apparatus and the card issuing machine provided by the application avoid the phenomena of step lost and speed reduced, and the location of the sensor assembly can be monitored in real time through the detecting plate.

### CROSS REFERENCE TO THE RELATED APPLICATIONS

This application is based upon and claims priority to Chinese Patent Application No. 201820888252.6, filed on Jun. 8, 2018, the entire contents of which are incorporated herein by reference.

### FIELD OF TECHNOLOGY

The application relates to the field of mechanical technologies, and more particularly, to a positioning apparatus and a card issuing machine.

### BACKGROUND

In the prior art, a positioning apparatus generally adopts a stepping motor or a servo motor, which not only is prone to the phenomena of step lost and speed reduced, but also is higher in costs and occupies larger space, leading to failure of monitoring a location in real time.

### SUMMARY

In view of the aforementioned problems, the application provides a positioning apparatus and a card issuing machine to overcome the aforementioned problems or at least partially solve the aforementioned problems.

To solve the above problems, the application discloses a positioning apparatus, which includes a sensor assembly, a moving member, and a detecting plate. The sensor assembly includes a sensor positioning and detecting assembly and a sensor location recognition assembly. The sensor assembly is mounted on the moving member, and the moving member drives the sensor assembly to move on the detecting plate.

The sensor assembly moves on the detecting plate, the sensor location recognition assembly recognizes that the sensor assembly reaches a designated location, and the sensor assembly is positioned by the sensor positioning and detecting assembly.

Preferably, the sensor positioning and detecting assembly includes two signal sensors.

Preferably, the sensor location recognition assembly includes eight signal sensors.

Preferably, the detecting plate is provided with a plurality of apertures, such that signals from the signal sensors penetrate through the apertures.

Preferably, recognizing, by the sensor location recognition assembly, that the sensor assembly reaches a designated location includes:

separately detecting whether each of the signal sensors in the sensor location recognition assembly is shielded;

recording status information of each of the signal sensors, the status information including being shielded or being not shielded;

calculating out a current location of the sensor assembly according to the status information of each of the signal sensors;

determining whether the current location of the sensor assembly is the designated location; and

determining that the sensor assembly has reached the designated location if it is determined that the current location of the sensor assembly is the designated location.

Preferably, the status information of each of the signal sensors is recorded using binary values.

The current location of the sensor assembly is determined by a corresponding binary value.

Preferably, positioning the sensor assembly by the sensor positioning and detecting assembly includes:

determining whether the signals from the signal sensors in the sensor positioning and detecting assembly penetrate through the apertures simultaneously; and

determining that the sensor assembly is positioned successfully if it is determined that the signals from the signal sensors in the sensor positioning and detecting assembly penetrate through the apertures simultaneously; otherwise

the sensor assembly moving on the detecting plate until the signals from the signal sensors in the sensor positioning and detecting assembly penetrate through the apertures simultaneously.

Preferably, the signal sensor includes a bijective optocoupler, or an emission-type optocoupler, or a laser generator, or an ultrasonic wave, or a Hall device, or an inductive coil.

Preferably, the detecting plate includes a silk screen, or a film, or a salient point, or an aperture.

An embodiment of the application discloses a card issuing machine, which includes a lateral positioning apparatus and a vertical positioning apparatus. The lateral positioning apparatus and the vertical positioning apparatus employ the positioning apparatus according to any one of the above embodiments.

The application includes the following advantages.

In the embodiment of the application, the positioning apparatus includes a sensor assembly, a moving member, and a detecting plate. The sensor assembly includes a sensor positioning and detecting assembly and a sensor location recognition assembly. The sensor assembly is mounted on the moving member, and the moving member drives the sensor assembly to move on the detecting plate. The sensor assembly moves on the detecting plate, the sensor location recognition assembly recognizes that the sensor assembly reaches a designated location, and the sensor assembly is positioned by the sensor positioning and detecting assembly. In this way, the moving member drives the sensor assembly to move together, thereby avoiding the phenomena of step lost and speed reduced, and the location of the sensor assembly can be monitored in real time through the detecting plate. Furthermore, the card issuing machine provided by the application is lower in cost than a stepping motor or a servo motor, and occupies smaller space.

### BRIEF DESCRIPTION OF THE DRAWINGS

FIG. 1 is a schematic structural diagram of a positioning apparatus according to the application;

FIG. 2 is a front view of a schematic structural diagram of a positioning apparatus according to the application;

FIG. 3 is a schematic status diagram of a first layer location of a positioning apparatus according to the application;

FIG. 4A-FIG. 4B are schematic process diagrams of a positioning apparatus moving from a first layer location to a second layer location according to the application; and

FIG. 5A-FIG. 5B are schematic process diagrams of a positioning apparatus moving from a second layer location to a third layer location according to the application.

### DESCRIPTION OF THE EMBODIMENTS

To make the foregoing objectives, features, and advantages of the application more apparent and lucid, the application is further described in detail below with reference to the accompanying drawings and embodiments.

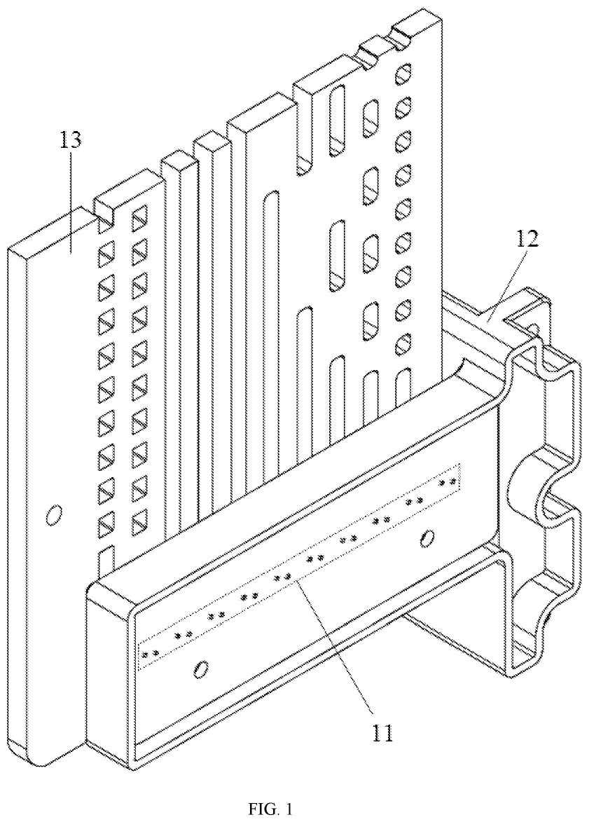

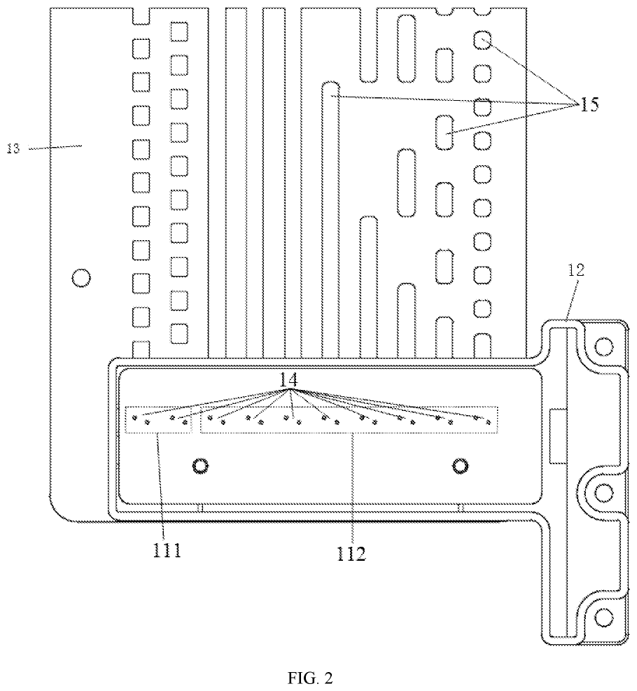

Referring to FIG. 1, a structural block diagram of a positioning apparatus according to the application is illustrated, and the positioning apparatus may specifically include a sensor assembly 11 (for clarity of understanding, an auxiliary mark is indicated by a dashed line in FIG. 1), a moving member 12, and a detecting plate 13. Referring to FIG. 2, the sensor assembly 11 includes a sensor positioning and detecting assembly 111 and a sensor location recognition assembly 112 (for clarity of understanding, an auxiliary mark is indicated by a dashed line in FIG. 2). The sensor positioning and detecting assembly 111 is configured to finely tune the location of the sensor assembly 11, and the sensor location recognition assembly 112 is configured to move the sensor assembly 11 to a designated location. In actual application, the sensor assembly 11 is first moved to the designated location based on the sensor location recognition assembly 112, and then the location of the sensor assembly 11 is finely tuned based on the sensor positioning and detecting assembly 111 until the sensor assembly 11 is accurately positioned. The sensor positioning and detecting assembly 111 may include two signal sensors 14, the sensor location recognition assembly 112 may include eight signal sensors 14, and the ten signal sensors 14 are arranged in line.

Of course, the specific number of the signal sensors 14 in the sensor positioning and detecting assembly 111 and the sensor location recognition assembly 112 may also be set according to actual needs, which is not limited by the embodiments of the application.

The sensor assembly 11 is mounted on the moving member 12, and the moving member 12 drives the sensor assembly 11 to jointly move on the detecting plate 13. The sensor assembly 11 moves on the detecting plate 13, and after the sensor location recognition assembly 112 recognizes that the sensor assembly 11 has reached the designated location, the sensor positioning and detecting assembly 111 positions the sensor assembly 11.

The detecting plate 13 is fixed, and the sensor assembly 11 may be either in contact with or not in contact with the detecting plate 13. For example, supposing a sensor in the sensor assembly needs to capture a signal by way of contact, the sensor assembly 11 may be in contact with the detecting plate 13, or supposing the sensor in the sensor assembly does not need to capture a signal by way of contact, the sensor assembly 11 may be not in contact with the detecting plate 13, which may be set according to actual needs and not limited in the embodiments of the application.

Referring to FIG. 2, in a preferred embodiment of the application, the detecting plate is provided with a plurality of apertures 15 (the apertures marked in FIG. 2 are only schematic, not only three), such that signals from the signal sensors penetrate through the apertures 15. The shapes of the apertures may be circular, rectangular, strip-shaped, or the like, which is not limited by the embodiments of the application.

The signal sensor includes but is not limited to a bijective optocoupler, or an emission-type optocoupler, or a laser generator, or an ultrasonic wave, or a Hall device, or an inductive coil, etc. The detecting plate includes but is not limited to a silk screen, or a film, or a salient point, or an aperture and so on, which is used for shielding or reflecting light or signals, or for electromagnetic induction, etc.

That is, any apparatus may serve as the signal sensor as long as it can generate a signal that may penetrate through the aperture or be shielded by the detecting plate, which is not limited in the embodiments of the application.

In a preferred embodiment of the application, recognizing, by the sensor location recognition assembly, that the sensor assembly reaches a designated location includes:

separately detecting whether each of the signal sensors in the sensor location recognition assembly is shielded;

recording status information of each of the signal sensors, the status information including being shielded or being not shielded;

calculating out a current location of the sensor assembly according to the status information of each of the signal sensors;

determining whether the current location of the sensor assembly is the designated location; and

determining that the sensor assembly has reached the designated location if it is determined that the current location of the sensor assembly is the designated location.

In a preferred embodiment of the application, the status information of each of the signal sensors is recorded using binary values.

The current location of the sensor assembly is determined by a corresponding binary value.

Specifically, the status information is marked as 0 when the signal sensor is shielded, and the status information is marked as 1 when the signal sensor is not shielded, or the status information is marked as 1 when the signal sensor is shielded, and the status information is marked as 0 when the signal sensor is not shielded, and then the location of the sensor assembly is determined according to the binary value of each of the signal sensors in the sensor location recognition assembly. For example, the sensor location recognition assembly includes eight optocouplers, and the binary values of the eight optocouplers are 0/0/0/0/0/0/1/0, respectively. In this case, the location of an optocoupler plate is a “00000010” layer location. The binary value may also be converted into a decimal value, which is 2, and i.e., “3” layer location when applying to the device. The binary value 00000000 may be converted into a decimal value which is 0, i.e., “1” layer location when applying to the device.

In practical application, when an instruction indicating that the sensor assembly has moved to a designated location is received, the sensor assembly may move toward the designated location. In the movement process of the sensor assembly, status information of the sensor location recognition assembly is continuously recognized. When the status information of the sensor location recognition assembly is consistent with the status information corresponding to the designated location, it may be determined that the sensor assembly has reached the designated location.

In a preferred embodiment of the application, positioning the sensor assembly by the sensor positioning and detecting assembly includes:

determining whether the signals from the signal sensors in the sensor positioning and detecting assembly penetrate through the apertures simultaneously; and

determining that the sensor assembly is positioned successfully if it is determined that the signals from the signal sensors in the sensor positioning and detecting assembly penetrate through the apertures simultaneously; otherwise

the sensor assembly moving on the detecting plate until the signals from the signal sensors in the sensor positioning and detecting assembly penetrate through the apertures simultaneously.

Specifically, after the sensor assembly has reached the designated location, to ensure the sensor assembly may position more accurately, the sensor positioning and detecting assembly needs to position the sensor assembly. Referring to FIG. 2, two vertical rows of apertures corresponding to two sets of signal sensors in the sensor positioning and detecting assembly (two vertical rows of apertures on the leftmost side of the detecting plate 13) are not parallel on the horizontal line, but are staggered and contain a common region. The so-called common region refers to a region where signals from the two sets of signal sensors can penetrate through the apertures simultaneously. In this way, in the case where the signals from the two sets of signal sensors can penetrate through the apertures simultaneously, the common region is smaller, and the sensor assembly may be positioned more accurately.

After the sensor assembly has reached the designated location, if the signals from each of the signal sensors in the sensor positioning and detecting assembly do not penetrate through the apertures simultaneously, the sensor assembly is finely tuned until the signals from each of the signal sensors in the sensor positioning and detecting assembly penetrate through the apertures simultaneously.

The application is specifically described below by way of specific examples.

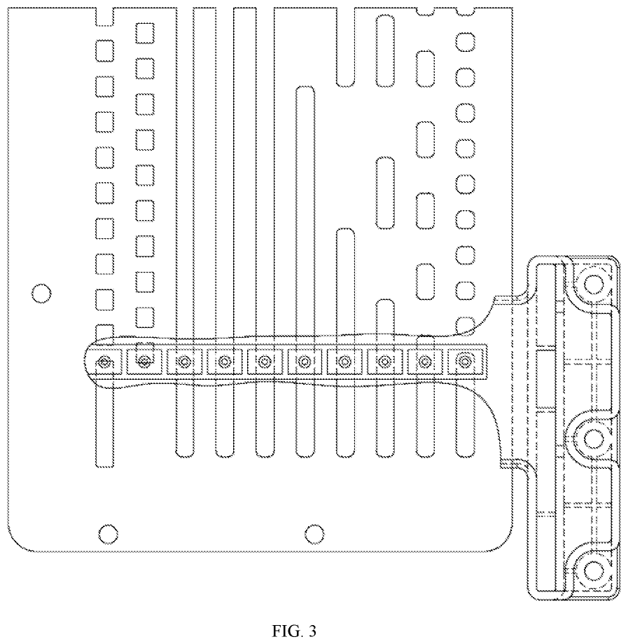

Referring to FIG. 3, the two signal sensors in the sensor positioning and detecting assembly are respectively in two staggered apertures and simultaneously transmit light, and the eight signal sensors in the sensor location recognition assembly are also respectively in different apertures and simultaneously transmit light. Supposing the signal sensors that transmit light are marked as “0” and the signal sensors that do not transmit light are marked as “1”, the information returned is “0/0, 0/0/0/0/0/0/0/0”, which is decoded as the eight signal sensors being positioned in the first layer. That is, the initial location of the sensor assembly is the first layer location.

It is to be noted that for ease of description, the ten signal sensors in FIG. 3 are No. 1 signal sensor to No. 10 signal sensor from left to right, and the same applies hereinafter. The first two “0/0” in the “0/0, 0/0/0/0/0/0/0/0” represent the No. 1 signal sensor and the No. 2 signal sensor in the sensor positioning and detecting assembly, and the last eight “0/0/0/0/0/0/0/0” represent the No. 3 signal sensor to the No. 10 signal sensor in the sensor location recognition assembly. Moreover, for the sensor positioning and detecting assembly, “0/0” represents that the sensor assembly has been accurately positioned, and “1/0” or “0/1” represents that the sensor assembly is not positioned successfully.

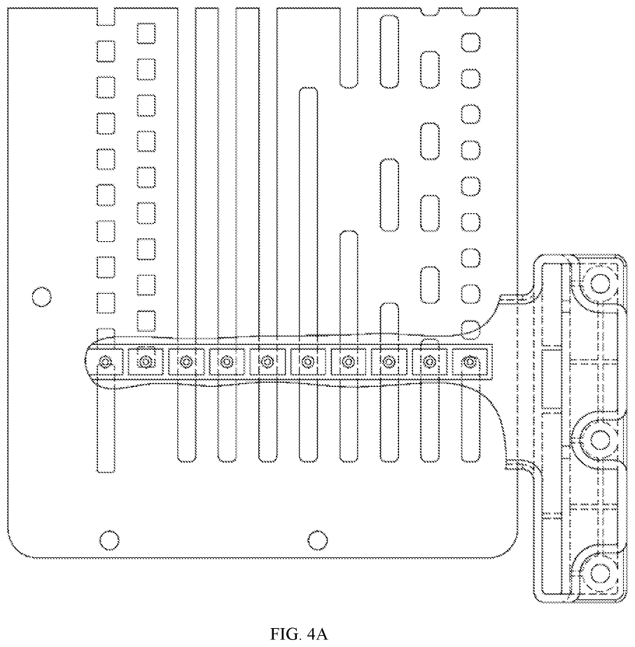

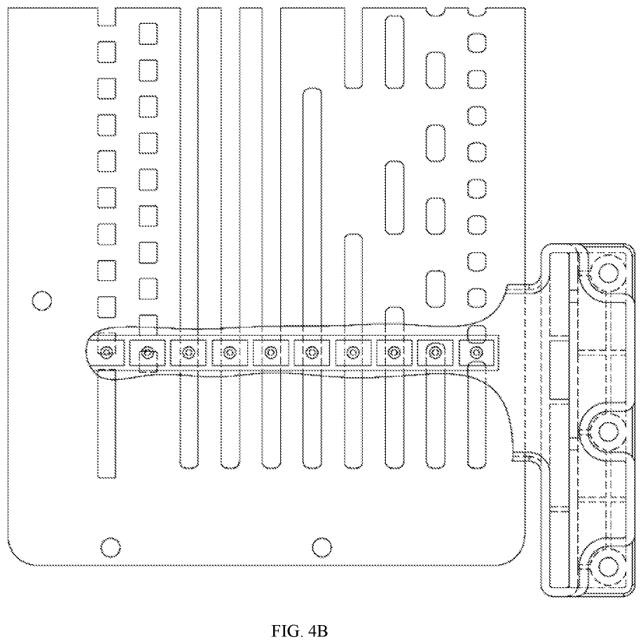

When the sensor assembly moves to the second layer, the ten signal sensors move up simultaneously. First, the No. 1 signal sensor is separated from a light transmission grid square and is shielded, and the No. 2 to No. 10 signal sensors are still in their respective apertures, and the information returned is “1/0, 0/0/0/0/0/0/0”, which is decoded as the sensor assembly being between the first layer and the second layer and near the first layer location at this moment. Referring to FIG. 4A, the sensor assembly continues moving upward, when the No. 1 signal sensor moves into the upper aperture and is in a light transmission state together with the No. 2 signal sensor simultaneously, the sensor assembly stops moving and completes the positioning, and the No. 3 to No. 9 signal sensors are still in the apertures, the No. 10 signal sensor moves out of the aperture and is shielded, the information returned is “0/0, 0/0/0/0/0/0/0/1”, which is decoded as being positioned at the second layer, referring to FIG. 4B.

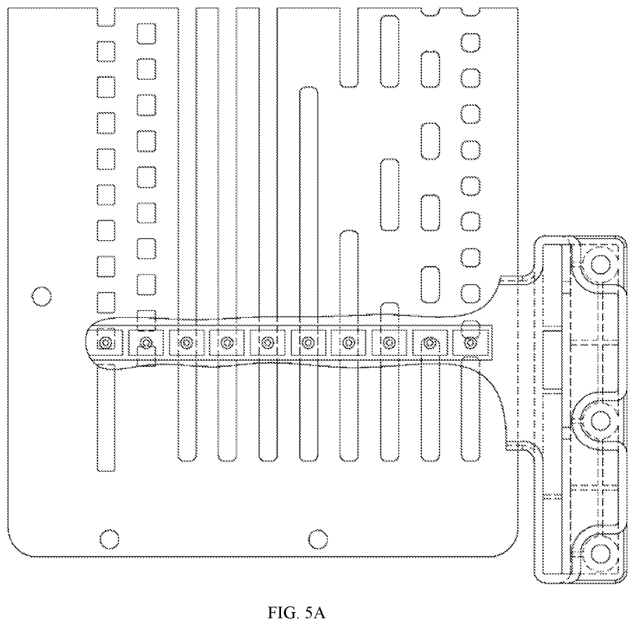

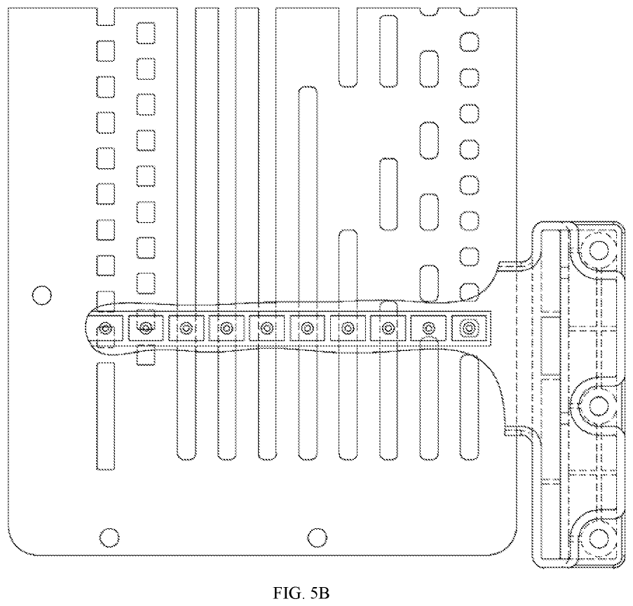

When the sensor assembly moves to the third layer, the ten signal sensors move up simultaneously. First, the No. 2 signal sensor is separated from the aperture and is shielded, the No. 1 signal sensor and the No. 3 to No. 9 signal sensors are still in their respective apertures, the No. 10 signal sensor is shielded, and the information returned is “0/1, 0/0/0/0/0/0/0/1”, which is decoded as the sensor assembly being between the second layer and the third layer and near the second layer location at this moment. Referring to FIG. 5A, the sensor assembly continues moving upward, when the No. 2 signal sensor moves into the upper aperture and is in the light transmission state together with the No. 1 signal sensor simultaneously, the sensor assembly stops moving and completes the positioning, and the No. 3 to No. 8 signal sensors are still in the apertures, the No. 9 signal sensor moves out of the aperture and is shielded, the No. 10 signal sensor moves into the upper aperture and is detected as light transmission, and the information returned is “0/0, 0/0/0/0/0/0/1/0”, which is decoded as being positioned at the third layer, referring to FIG. 5B.

It is to be noted that the No. 1 to No. 10 signal sensors are numbered for the purpose of illustration, such that the signal sensors are differentiated, and these signal sensors are identical.

In the embodiments of the application, the positioning apparatus includes a sensor assembly, a moving member, and a detecting plate. The sensor assembly includes a sensor positioning and detecting assembly and a sensor location recognition assembly. The sensor assembly is mounted on the moving member, and the moving member drives the sensor assembly to move on the detecting plate. The sensor assembly moves on the detecting plate, the sensor location recognition assembly recognizes that the sensor assembly reaches a designated location, and the sensor assembly is positioned by the sensor positioning and detecting assembly. In this way, the moving member drives the sensor assembly to move together, thereby avoiding the phenomena of step lost and speed reduced, and the location of the sensor assembly can be monitored in real time through the detecting plate. Furthermore, the card issuing machine provided by the application is lower in cost than a stepping motor or a servo motor, and occupies smaller space.

An embodiment of the present invention discloses a card issuing machine, which includes a lateral positioning apparatus and a vertical positioning apparatus. The lateral positioning apparatus and the vertical positioning apparatus employ the positioning apparatus according to the above embodiments. The lateral positioning apparatus is a positioning apparatus formed by rotating the positioning apparatus to the left or right by 90 degrees.

Finally it should be explained that a relational term (such as a first or a second) is merely intended to separate one entity or operation from another entity or operation instead of requiring or hinting any practical relation or sequence exists among these entities or operations. Furthermore, terms such as “comprise”, “include” or other variants thereof are intended to cover a non-exclusive “comprise” so that a process, a method, a merchandise or a terminal device comprising a series of elements not only includes these elements, but also includes other elements not listed explicitly, or also includes inherent elements of the process, the method, the merchandise or the terminal device. In the case of no more restrictions, elements restricted by a sentence “include a” do not exclude the fact that additional identical elements may exist in a process, a method, a merchandise or a terminal device of these elements.

A positioning apparatus and a card issuing machine provided by the application are described in detail above. Principles and implementations of the application are elaborated by using specific examples herein, and the description of the foregoing embodiments is merely intended to assist in understanding the method of the application and the core concept thereof. Also, those of ordinary skill in the art may change, in according with the concept of the application, a concrete implementation and a scope of application. In conclusion, contents of the specification shall be not interpreted as limiting the application.

What is claimed is:

1. A positioning apparatus, comprising:
a sensor assembly, a moving member, and a detecting plate;
wherein the sensor assembly comprises a sensor positioning and detecting assembly and a sensor location recognition assembly;
the sensor assembly is mounted on the moving member, and the moving member is configured to drive the sensor assembly to move on the detecting plate; and
the sensor location recognition assembly is configured to determine when the sensor assembly reaches a designated location, and the sensor positioning and detecting assembly is configured to position the sensor assembly.

2. The apparatus according to claim 1, wherein the sensor positioning and detecting assembly comprises two signal sensors.

3. The apparatus according to claim 1, wherein the sensor location recognition assembly comprises eight signal sensors.

4. The apparatus according to claim 1, wherein the detecting plate is provided with a plurality of apertures, such that signals from the signal sensors penetrate through the apertures.

5. The apparatus according to claim 1, wherein determining, by the sensor location recognition assembly, that the sensor assembly reaches the designated location comprises:
separately detecting whether each of the signal sensors in the sensor location recognition assembly is shielded;
recording status information of each of the signal sensors, the status information comprising being shielded or being not shielded;
calculating out a current location of the sensor assembly according to the status information of each of the signal sensors;
determining whether the current location of the sensor assembly is the designated location; and
determining that the sensor assembly has reached the designated location if the current location of the sensor assembly is the designated location.

6. The apparatus according to claim 5, wherein the status information of each of the signal sensors is recorded using binary values; and
the current location of the sensor assembly is determined by a corresponding binary value.

7. The apparatus according to claim 4, wherein positioning the sensor assembly by the sensor positioning and detecting assembly comprises:
determining whether the signals from the signal sensors in the sensor positioning and detecting assembly penetrate through the apertures simultaneously; and
determining that the sensor assembly is positioned successfully if the signals from the signal sensors in the sensor positioning and detecting assembly penetrate through the apertures simultaneously; otherwise
the sensor assembly moving on the detecting plate until the signals from the signal sensors in the sensor positioning and detecting assembly penetrate through the apertures simultaneously.

8. The apparatus according to claim 1, wherein the signal sensor comprises a bijective optocoupler, or an emission-type optocoupler, or a laser generator, or an ultrasonic wave, or a Hall device, or an inductive coil.

9. The apparatus according to claim 1, wherein the detecting plate comprises a silk screen, or a film, or a salient point, or an aperture.

10. A card issuing machine, comprising: a lateral positioning apparatus and a vertical positioning apparatus, wherein the lateral positioning apparatus and the vertical positioning apparatus comprise the positioning apparatus according to claim 1.

11. The card issuing machine according to claim 10, wherein the sensor positioning and detecting assembly comprises two signal sensors.

12. The card issuing machine according to claim 10, wherein the sensor location recognition assembly comprises eight signal sensors.

13. The card issuing machine according to claim 10, wherein the detecting plate is provided with a plurality of apertures, such that signals from the signal sensors penetrate through the apertures.

14. The card issuing machine according to claim 10, wherein determining, by the sensor location recognition assembly, that the sensor assembly reaches the designated location comprises:
separately detecting whether each of the signal sensors in the sensor location recognition assembly is shielded;
recording status information of each of the signal sensors, the status information comprising being shielded or being not shielded;
calculating out a current location of the sensor assembly according to the status information of each of the signal sensors;
determining whether the current location of the sensor assembly is the designated location; and
determining that the sensor assembly has reached the designated location if the current location of the sensor assembly is the designated location.

15. The card issuing machine according to claim 14, wherein the status information of each of the signal sensors is recorded using binary values; and
the current location of the sensor assembly is determined by a corresponding binary value.

16. The card issuing machine according to claim 13, wherein positioning the sensor assembly by the sensor positioning and detecting assembly comprises:
determining whether the signals from the signal sensors in the sensor positioning and detecting assembly penetrate through the apertures simultaneously; and
determining that the sensor assembly is positioned successfully if the signals from the signal sensors in the sensor positioning and detecting assembly penetrate through the apertures simultaneously; otherwise
the sensor assembly moving on the detecting plate until the signals from the signal sensors in the sensor positioning and detecting assembly penetrate through the apertures simultaneously.

17. The card issuing machine according to claim 10, wherein the signal sensor comprises a bijective optocoupler, or an emission-type optocoupler, or a laser generator, or an ultrasonic wave, or a Hall device, or an inductive coil.

18. The card issuing machine according to claim 10, wherein the detecting plate comprises a silk screen, or a film, or a salient point, or an aperture.
